(19) United States
(12) Patent Application Publication
(10) Pub. No.: US 2024/0397581 A1
(43) Pub. Date: Nov. 28, 2024

(54) Electrical Connector for a Heating System, Heating System, and Method for Installing a Heat Shrink Cover

(71) Applicant: Tyco Electronics Raychem GmbH, Ottobrunn (DE)

(72) Inventors: Thilo Simonsohn, Ottobrunn (DE); Ladislaus Kehl, Ottobrunn (DE); Thomas Schoepf, Ottobrunn (DE)

(73) Assignee: Tyco Electronics Raychem GmbH, Ottobrunn (DE)

(21) Appl. No.: 18/792,071

(22) Filed: Aug. 1, 2024

Related U.S. Application Data
(63) Continuation of application No. PCT/EP2023/050549, filed on Jan. 11, 2023.

(30) Foreign Application Priority Data
Jan. 13, 2022 (EP) 22151363.3

(51) Int. Cl. H05B 3/06; H05B 1/02

(52) U.S. Cl. CPC H05B 3/06; H05B 1/023

(57) ABSTRACT

An electrical connector includes a first connector element having a housing and a first power terminal providing electrical power to a heating element of a heating system, and a second connector element mateable with the first connector element. The second connector element has a second power terminal mateable with the first power terminal. The electrical connector includes an information storage unit storing a data usable for operating the heating system and a communication interface reading out the data stored in the information storage unit.

### CROSS-REFERENCE TO RELATED APPLICATIONS

This application is a continuation of PCT International Application No. PCT/EP2023/050549, filed on Jan. 11, 2023, which claims priority under 35 U.S.C. § 119 to European Patent Application No. 22151363.3, filed on Jan. 13, 2022.

### FIELD OF THE INVENTION

The present invention relates to an electrical connector and, more particularly, to an electrical connector for a heating system.

### BACKGROUND OF THE INVENTION

The majority of existing medium voltage (MV) joints comprise heat shrink joint bodies together with mastics, stress control sleeves, or patches underneath. On the outside of the heat shrink bodies, conductive meshes are taped, and the shield wires or tape shields of the cables are connected from one end of the joint to the other. Finally, the entire connection area is usually covered by a heat shrink outer protection sleeve, often referred to as the rejacketing sleeve.

Heat shrink components relate to articles that are made from material which shrinks from an expanded state into a shrunk state with a much smaller diameter by applying a sufficient amount of heat. Heat shrink components are widely used as joint sleeves or other cable accessories.

A heat-recoverable article (an independently dimensionally heat-unstable article) can be used as a heat shrink layer. In general, such an article is made of a material capable of having the property of elastic or plastic memory imparted thereto which is heated to a certain temperature and distorted e. g. under internal pressure to a configuration different from its normal configuration and then cooled while kept under pressure. If the article is made of a material which is partly crystalline, is at least partly cross-linked in the amorphous areas, and is distorted at a temperature at or above the crystalline melting point of the material, the article will have elastic memory. An article with elastic memory will not recover towards its original configuration until it is again heated at least to its crystalline melting temperature. If the article is made of a non-crystalline material, it is heated to a temperature at which the article can be distorted by pressure, and the distorted article then has the property of plastic memory. Examples of heat-recoverable materials are found in U.S. Pat. Nos. 2,027,962 and 3,086,242. Of course, the heat shrink layer can be fabricated from any suitable material. Moreover, multilayer arrangements that additionally comprise elastic and/or electrically semi-conductive and conductive layers are encompassed by the present disclosure.

In order to install heat shrink products, typically open flames, such as gas torches, are used. However, from the perspective of safety at work, the use of open flames is disadvantageous. Furthermore, it is desired to reduce the amount of energy needed for installing products. In some cases, it is also desired to reduce the amount of heat generated during installation. Consequently, it is desirable to use energy sources other than open flames, such as electrical energy. In particular, it is desirable that the joint body and the rejacketing sleeve can be installed torchlessly in one process without further interaction of a cable jointer.

For instance, from EP 3 624 288 A1, such a heating system is known. Further, it is known to provide the installation kit with an identification tag for identifying the type and structure of the heat shrink cover, so that an operator can read the information on the identification tag by an identification reader, for instance a bar code or QR code reader. The identification reader is connected to the control unit via a cable.

However, a problem with bar code or QR identification tags is that the jointer may be reading the tags of neighbored joints, so that the control unit is using incorrect heating sequences, and the reading procedure is sometimes difficult to execute due to outdoor installation sites. The bar codes or QR identification tags can be lost or could be easily removed from the heat-shrink joint and re-used for other, supposedly identical joints, but slightly modified installation sequence (e.g. due to a change of the internal heater circuits). Furthermore, the information stored by bar code or QR identification tags cannot be altered or supplemented on-site during or after the installation process.

Consequently, there is still a need to improve existing heating systems for heat shrink covers and methods for installing a heat shrink cover onto a component to be covered, which alleviate or overcome the disadvantages of conventional installation methods and provide a significant reduction of installation time, manufacturing costs, and the complexity, and improve the way the product and installation data is being retrieved by the control unit.

### SUMMARY OF THE INVENTION

An electrical connector includes a first connector element having a housing and a first power terminal providing electrical power to a heating element of a heating system, and a second connector element mateable with the first connector element. The second connector element has a second power terminal mateable with the first power terminal. The electrical connector includes an information storage unit storing a data usable for operating the heating system and a communication interface reading out the data stored in the information storage unit.

### BRIEF DESCRIPTION OF THE DRAWINGS

Features and advantages will become apparent from the following more particular description of the various embodiments of the invention, as illustrated in the accompanying drawings, in which like references refer to like elements, and wherein:

FIG. 1 is a schematic perspective view, partly exploded, of an electrical connector according to a first embodiment;

FIG. 2 is a further view of the electrical connector of FIG. 1;

FIG. 3 is a schematic illustration of an example of a heating system for heat shrinking heat recoverable articles;

FIG. 4 is a schematic perspective view of an electrical connector according to a second embodiment;

FIG. 5 is a further view of the electrical connector of FIG. 4;

FIG. 6 is a perspective view of a part of the electrical connector of FIG. 4; and

FIG. 7 is a further perspective view of another part of the electrical connector of FIG. 4.

### DETAILED DESCRIPTION

The accompanying drawings are incorporated into the specification and form a part of the specification to illustrate several embodiments of the present invention. These drawings, together with the description, explain the principles of the invention. The drawings are merely for the purpose of illustrating examples of how the invention can be made and used, and are not to be construed as limiting the invention to only the illustrated and described embodiments. Furthermore, several aspects of the embodiments may form—individually or in different combinations—solutions according to the present invention. The following described embodiments thus can be considered either alone or in an arbitrary combination thereof.

In an embodiment, the present disclosure can be used for installing medium voltage (MV) joint bodies for 12 to 42 kV single-core and three-core cables, but may also be advantageous for covering other components and can be used in other voltage classes. In particular, the heat shrink cover disclosed herein may be employed for installing heat shrink joint bodies and rejacketing sleeves as well as in principle all kinds of heat shrink sleeves such as terminations and cover sleeves as well as molded products like sheds, breakouts, boots and caps. The present disclosure further relates to an installation kit and an installation system for installing a heat shrink cover torchlessly.

The heat shrink cover according to the present disclosure can be used with voltages above approximately 1 kV. In particular, the term “high-voltage” in the context of the present invention is intended to comprise the usual nominal voltage ranges of power transmission, namely medium voltage, MV, (about 3 kV to about 72 kV), high-voltage, HV, (about 72 kV to about 245 kV), and also extra high-voltage (up to presently about 500 kV). Of course, also higher voltages may be considered in the future. These voltages may be direct current (DC) or alternating current (AC) voltages. In the following, the term “high-voltage cable” is intended to signify a cable that is suitable for carrying electric current of more than about 1 A at a voltage above approximately 1 kV. Accordingly, the term “high-voltage accessory” is intended to signify a device that is suitable for interconnecting high-voltage facilities and/or high-voltage cables. In particular, a high-voltage accessory may either be an end termination or a cable joint.

The present disclosure is also applicable to the so-called “low-voltage”, LV, range that relates to voltages below 1 kV. The principles of the present disclosure may further be applied to heat shrink products used for electronic applications, piping and construction applications, and other applications.

The expression “sleeve” according to the present disclosure is intended to signify straight tube-shaped sleeves as well as differently shaped covers for branch joints, elbows, bends, breakouts, wrap-arounds, sheds, and the like. Moreover, the term “heat shrink sleeve” is intended to comprise such a product which has at least one heat shrink layer, so that the heat shrink sleeve is heat-recoverable. In other words, a heat shrink sleeve according to the present invention may be partly or completely formed from a heat-recoverable material.

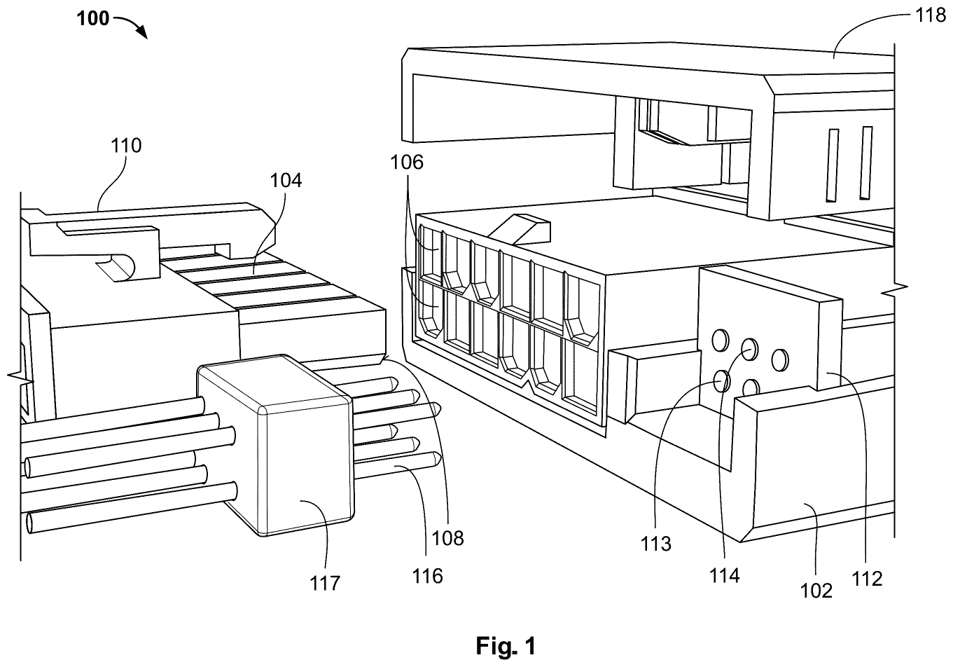

The present invention will now be explained in more detail with reference to the Figures and firstly referring to FIG. 1.

To avoid open flames during the installation process of medium voltage heat-shrink joints and to improve reliability of the installation process, a heat shrink joint family has been developed, where each heat shrink joint (also referred to as heat shrink cover) is equipped with an electrical heater unit. The heater unit comprises one or more heater circuits (also referred to as heating elements), which need to be energized with changing power levels and in a specific sequence to generate a heat-wave starting in the center of the joint, which is like the heat-wave achieved by the manual shrinking process with a torch. The installation process is beneficially carried out by an electrical control unit, which can install up to three joints simultaneously.

Due to the different sizes of the joints, the design of the heater circuits as well as the heating sequences vary. In order to cope with this situation, with previous heating systems, the operator must manually enter the heater sequences into the controller and to keep the control unit universal (i.e. not needing to store all different heater sequences within the control unit) it is beneficial, if the sequence and all other relevant information, like batch number, manufacturing date, etc. is provided to the control unit in an automated way.

For the installation of the earlier described heat shrink joint, a control unit (either battery powered or connected to mains or an AC generator) is connected to the heater unit of the joint. A heater unit can, for instance, include up to twelve individual heater circuits, also referred to as heating elements in the following. In case that no common return contact is used, a total of twenty-four individual contacts will be required to operate the heating elements.

For connecting the power terminals of the heating unit to the control unit, a plug connector is provided. FIG. 1 illustrates an electrical connector 100 according to an example of the present disclosure. The connector 100 comprises a first connector element 102 and a mating second connector element 104 that is mateable with the first connector element 102. The first and second connector elements 102, 104 are plugged together during the heating process for supplying electrical energy to the heating elements of the heating unit. It should be noted that the electrical leads which are attached to the heating unit are not shown in the figures for the sake of clarity.

In the shown exemplary embodiment, the first connector element 102 has six pairs of power terminal sockets 106 which are connected to the heating unit, wherein one pair of the power terminal sockets 106 is connected to one heating element. It should be noted that, in other embodiments, any other suitable number of power terminals can be used with the present disclosure. Moreover, instead of socket terminals, pin contacts can alternatively be provided at the first connector element 102.

In the embodiment shown in FIG. 1, the mating second connector element 104 is provided with pairs of power terminal pins 108 which can be plugged into the sockets 106 for establishing an electrical connection. The power terminal pins 108 are connected via a conductive lead to the control unit. In the connected state, a releasable locking element, e. g. a releasable latch hook 110 secures the first and second connector elements 102, 104 to each other.

An information storage unit 112, unit is a non-transitory electronic storage unit that comprises at least one read-only memory (ROM). The ROM may, for instance, be e. g. a programmable read-only memory (PROM), an erasable programmable read-only memory (EPROM), or an electrically erasable programmable read-only memory (EEPROM), is beneficially located within the receiving first connector 102 of the heater unit, automatically providing all the stored information to the control unit, when the connection is made. Depending on the type of PROM interface, a minimum of 1 (1-wire), 2 (I²C), or 3 (SPI) additional contacts will be required to read-out the data.

Generally, a PROM is a form of digital memory where the setting of each bit is locked by a fuse or antifuse, eFUSEs can also be used. The data in them are permanent and cannot be changed. PROMs are used in digital electronic devices to store permanent data, usually low level programs such as firmware or microcode. The key difference from a standard ROM is that the data is written into a ROM during manufacture, while with a PROM the data is programmed into them after manufacture. Thus, ROMs tend to be used only for large production runs with well-verified data, while PROMs are used to allow companies to test on a subset of the devices in an order before burning data into all of them.

PROMs are manufactured blank and, depending on the technology, can be programmed at wafer, final test, or in system. Blank PROM chips are programmed by plugging them into a device called a PROM programmer. In the context of the present disclosure, the PROM is programmed with the desired information when manufacturing the heating unit comprising one or more electrical heating elements. During the operational life, the information stored in the PROM is not changed again.

Further, erasable PROMs (EPROM) may be used for allowing a reprogramming to a limited extent.

The EEPROM can be used if it is desired that the information storage unit 112 is also used for storing further information during or after the installation process, e. g. for documentation purposes. An EEPROM is a user-modifiable read-only memory (ROM) that can be erased and reprogrammed (written to) repeatedly through the application of higher than normal electrical voltage. Unlike EPROM chips, EEPROMs do not need to be removed from the assembly position to be modified. However, an EEPROM chip has to be erased and reprogrammed in its entirety, not selectively. It also has a limited life-however, the number of times it can be reprogrammed is limited to tens or hundreds of thousands of times, which is more than enough for the present application.

The advantage of using an EEPROM over using a PROM lies in the fact that the control unit may also write installation specific details (e.g. installation date, installer ID, or the like) back into the memory for later use. This provides an additional benefit in case of failure analysis.

In addition, it becomes easily possible to write data into the memory during the manufacturing processes.

The number of electrical contacts depends on the interface technology of the information storage unit 112. In any embodiment, two contacts are provided for the power supply, one additional contact is provided if a 1-wire connection is used, alternatively or additionally, two contacts are provided for a communication according to the I²C (Inter-integrated circuit) protocol, namely serial clock line (SCL) and bidirectional serial data (SDA). With I²C, multiple slaves can be connected to one master, or multiple masters can control a single or multiple slaves. The I²C protocol uses only two wires to transmit data between devices: the SDA line and the SCL line which carries the clock signal for synchronizing the output of bits the sampling of bits. The clock signal is always controlled by the master.

In case the communication is performed using the Serial Peripheral Interface (SPI) protocol, three or four additional contacts are needed, namely for master in/slave out (MISO), master out/slave in (MOSI), serial clock (SCLK), and optionally slave select (SS). SPI is a common communication protocol used by many different devices. For example, secure digital (SD) card reader modules, radio frequency identification (RFID) card reader modules, and 2.4 GHz wireless transmitter/receivers all use SPI to communicate with microcontrollers.

One unique benefit of SPI is the fact that data can be transferred without interruption. Any number of bits can be sent or received in a continuous stream. With I²C, data is sent in packets, limited to a specific number of bits. Start and stop conditions define the beginning and end of each packet, so the data is interrupted during transmission.

Devices communicating via SPI are in a master-slave relationship. The master is the controlling device (usually a microcontroller), while the slave (usually a sensor, display, or memory chip) takes instruction from the master. The simplest configuration of SPI is a single master, single slave system, but one master can control more than one slave. Four lines are usually used, namely MOSI, the line for the master to send data to the slave; MISO, the line for the slave to send data to the master; SCLK, the line for the clock signal; SS/CS, the line for the master to select which slave to send data to.

However, it should be noted that the idea of the present invention is not restricted to a particular communication protocol—any suitable protocol may be used.

As shown in FIG. 1, an electrically insulating housing 118 encompasses the power terminals 106 and the information storage unit 112.

As shown in FIG. 1, the information storage unit 112 has a communication terminal 113 with a plurality of first contact elements 114 which are socket-shaped and can be electrically contacted by a mating plurality of second contact elements 116 arranged at a mating plug connector 117, when the connector 100 is plugged together. The second contact elements 116 are pin-shaped. Of course, the arrangement can also be vice versa, i. e. with the pins arranged at the first connector element 102 and the sockets arranged at the second connector element 104. Further, as mentioned above, the number of contact elements depends on the chosen communication protocol of the information storage unit 112.

In another embodiment, the ohmic contacts 114, 116 may also be completely dispensed with, if the information storage unit 112 is provided with a wireless communication interface, for instance a Bluetooth® communication interface. However, the ohmic contacts have the advantage that such a wired connection is robust, cost efficient, and hassle-free. Such a wireless communication interface allows access to the stored information even in situations where the power terminals are not connected, e. g. prior to the installation for testing purposes or after the installation for documentation purposes and failure analysis.

The second contact elements 116 are connected via electrical leads to the control unit. According to the present disclosure, a bidirectional communication can be performed via these contact elements, 114, 116, so that data may be retrieved from the information storage unit 112 and, furthermore, data may also be inputted and stored in the information storage unit 112. The data may, for instance, represent information regarding the type and identification of the heating system and/or may indicate a time-power sequence which should be used for operating the heating system. By automatically detecting the type of joint connected and transferring the correct installation procedure to the control unit, faulty installations due to wrong installation procedures can be completely avoided.

This ensures that the control unit may not only retrieve information from the information storage unit 112, such as the type of heating element(s) and/or the type and characteristics of a cover to be heat shrunk, which is already pre-assembled with the heating unit, but may also input further information into the information storage unit 112. As already mentioned, such further information may relate to the date of the installation and/or to the installer ID.

Additionally, the user guidance provided by the control unit is very much simplified by the automatic detection of the joint. For instance, the implementation of a keyboard, which may be required to key-in additional information, can be avoided. The control unit can also recognize immediately when the heater unit is disconnected again and would fall back into the initial state before the connection was done.

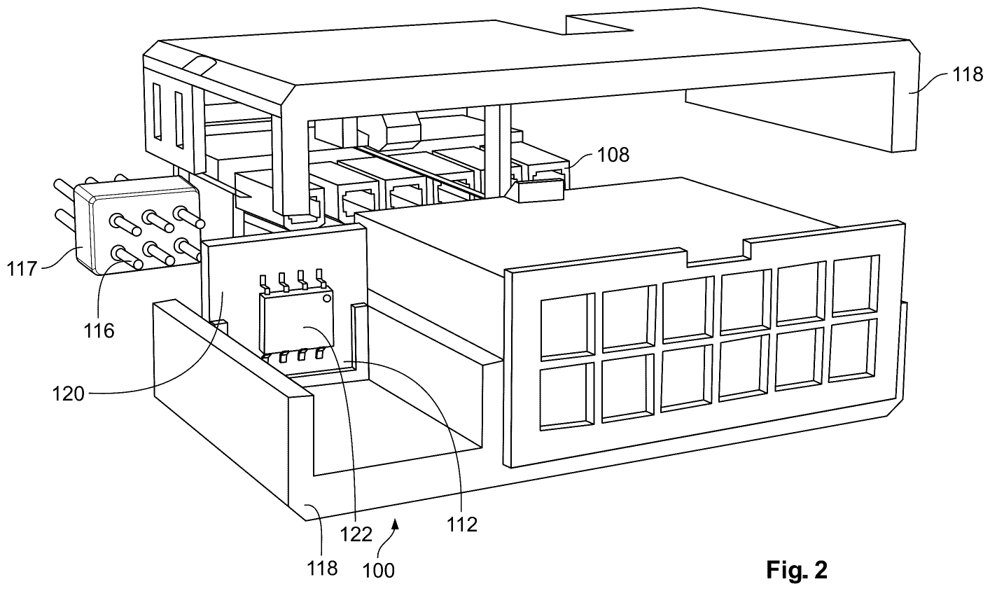

FIG. 2 shows the electrical connector 100 in a rotated view. As shown in FIG. 2, the information storage unit 112 comprises a circuit carrier, e. g. a printed circuit board (PCB) 120. As an electronic storage unit, a memory module 122 is assembled on the PCB 120. In another embodiment, a ceramic substrate or a flexible circuit board can be used instead of the PCB 120. Also three-dimensional carrier structures generated by molded interconnect device (MID) technology, so-called Three-Dimensional Molded Interconnect Devices (3D-MID), e. g. the inside of the housing 118, can be used as a substrate for mounting the memory module 122. The memory module 122, in an embodiment, is an electronic storage unit.

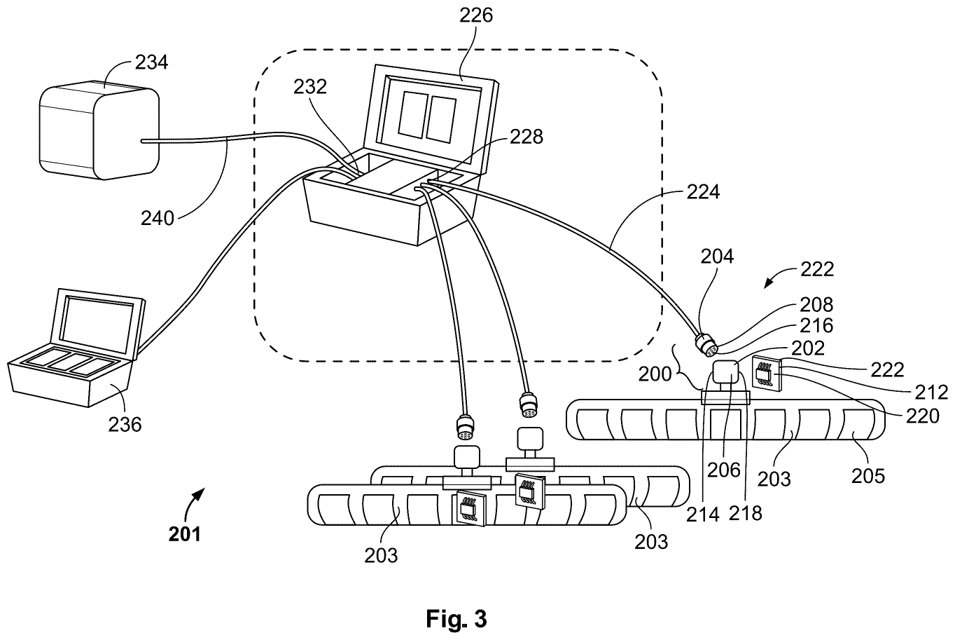

FIG. 3 illustrates schematically a heating system 201 using electrical plug connectors 200 according to a further example. It should be noted that instead of the electrical plug connector 200 also the electrical plug connector 100 of the previous Figures can be used. The heating system 201 comprises one or more heating units 203, each comprising one or more heating elements 205. These heating units 203 may also be pre-assembled on the heatshrink cover to be shrunk (i.e. installed).

The electrical connection for powering the heating elements 205 is provided by electrical connector 200. In the shown example, this is a circular connector with spring loaded pins at a second connector element 204, so-called “pogo pins”. They are used for their improved durability over other electrical contacts, and the resilience of their electrical connection to mechanical shock and vibration. Essentially, these pins are the same type of spring-loaded contacts as those used for connecting the memory, but with a much higher current rating.

The second connector element 204, which is mateable with the first connector element 204, also may have an information storage unit because the joint's structure and installation sequence may change during the life cycle of the final product. It cannot be ensured that jointers always pick products from their stock with identical batch numbers for installation. Secondly, joints may not always be sold as kits of three and in case of a replacement of a single product, it needs to be made sure that all details are provided to successfully install the product. Finally, the memory chip also includes the product's serial number and other unique information. Therefore, each product requires its own memory chip. In the shown embodiment, the second connector element 204 has a plurality of power terminal pins 208. The power terminal pins 208 are second contact elements 216.

A first connector element 202 is connected to the heating unit 203 for providing power to each of the heating elements 205. According to the present disclosure, the first connector element 202 is provided with an information storage unit 212 similar to the information storage unit 112 described with reference to FIGS. 1 and 2. The information storage unit 212 has a circuit carrier or PCB 220 with a memory module 222. It should be noted that FIG. 3 is only a schematic illustration, the information storage unit 212 is of course integrated inside a housing 218 of the first connector element 202.

The storage unit 212 may be located directly at the electrical connector connected to the electrical heating element(s) or at any other location on the product. The first connector element 202, in the shown embodiment, has a plurality of power terminal sockets 206 mateable with the power terminal pins 208. The power terminal pins 208 are first contact elements 214.

In an embodiment, the housing 218 may have two sections which are electrically insulated from each other. In a first section, the one or more pairs of power terminals 208 are held, and in a second section, the printed circuit board 220 with the information storage unit 212 is arranged.

The second connector element 204, as shown in FIG. 3, is connected via an electrical lead 224 to a control unit 226. The control unit 226 outputs electrical power to the heating unit(s) 203. The power is controlled by pulse width modulation (PWM). On the output side, the control unit 226 may have a plurality of output ports 228. In the drawing of FIG. 3, there are shown three output ports 228. However, it is clear that also less or more output ports 228 can be provided. Connectors with information storage units may also be used for the connectors 200 attached to the electrical output leads 224 so that a correct connection of such a lead 224 can be monitored.

On the input side, the control unit 226 has at least one input port 232. To the input port 232, either a power generator 234 or a battery pack 236 may be connected via an electrical input lead 240 to form a power source for the heating. Also a connection to mains power may be established via a mains plug. The power source may be connected to the electrical connector attached to the heating unit 203 either directly or via a separate control unit. The at least one of the power generator 234 and/or battery pack 236 further comprise an electrical connector as described above for allowing a bidirectional communication with the control unit 226. Thus, the control unit 226 may identify the type and characteristics of the connected power source and may adapt the control scheme for powering the heating unit to the particular power source.

As schematically illustrated, each connector in the heating system 201 may be provided with information storage unit 212 according to the present disclosure in order to identify the respectively connected components. For instance, information from and to the battery management system (BMS) of the battery pack 236 can be stored in an information storage unit arranged in a connector attached to the battery pack 236.

There is an electrically conductive, in particular a wired connection between the information storage unit 212 and the control unit 226. This allows the control unit 226 to automatically detect the type of joint connected and to retrieve the correct installation procedure. Thus, faulty installation due to the use of wrong installation procedures (in particular, temperature profile) can be avoided.

The identification of further components required by the control unit 226 can be performed in line with the principles of the present disclosure. PROMs may be added into all connectors of connected cables (AC power, battery cables) as well as batteries and intermediate plugs, etc. for identification purposes but also for keeping track of the number of uses, in case there are wearing parts with a maximum number of using cycles. In an embodiment, EEPROMs can be used over PROMs, since the control unit 226 could then also write installation specific details (e.g. installation date, installer ID, or the like) back into the memory for later use. This could provide an additional benefit in case of failure analysis. The control unit 226 controls the power supply to the at least one heating element 205. The control unit 226 is operable to bidirectionally communicate with the electronic storage unit 212.

RFID tags could also be used beneficially as the information storage unit 112 to achieve a similar functionality. However, there are further aspects to be considered: the RFID tag's information may need to be assigned manually to a specific output of the control unit 226. A mismatch cannot be detected by the control unit 226 in all cases. To some extent, plausibility checks can be used to identify improper assignment of data. RFID tags could be easily removed from the heat-shrink joint and re-used for other, supposedly identical joints, but slightly modified installation sequence (e.g. due to a change of the internal heater circuits). Disconnecting/reconnecting joints may not be detectable by the control unit 226.

However, these disadvantages can be avoided by placing RFID readers directly into the second connector element 204 of each connector 200 with the corresponding RFID tag being placed hidden in the mating first connector element 202. This solution has the advantage that a robust, well-established, and low-cost technology is employed which furthermore does not need an ohmic contact for transmitting the information.

RFID (Radio-Frequency Identification) designates a contactless data exchange between an RFID transponder and an RFID writer/reader device. The RFID writer/reader device builds up a magnetic or electromagnetic field for data transmission purposes, which supplies the RFID transponder with energy. As long as the RFID transponder remains within the electromagnetic field of the RFID writer/reader device, data can be exchanged. Information can be read out from the chip in the RFID transponder, but also new data can be stored on the chip.

By locating the RFID writer/reader device inside the mating second connector 204, a separation of the plug connection may also be detected.

The use of a connector 200 at the power input line of the heating element(s) 205 simplifies user-machine interactions and avoids accidental mismatch of products or false handling of the control unit 226 including any connected cables. Further, any re-use of identification data and related data sets can be prevented.

In another embodiment, the first connector element 202 is further adapted to receive a temperature measurement signal from one or more external temperature sensors. The temperature sensor(s) may for instance be attached to the heat shrink cover in order to monitor the actually achieved temperature values.

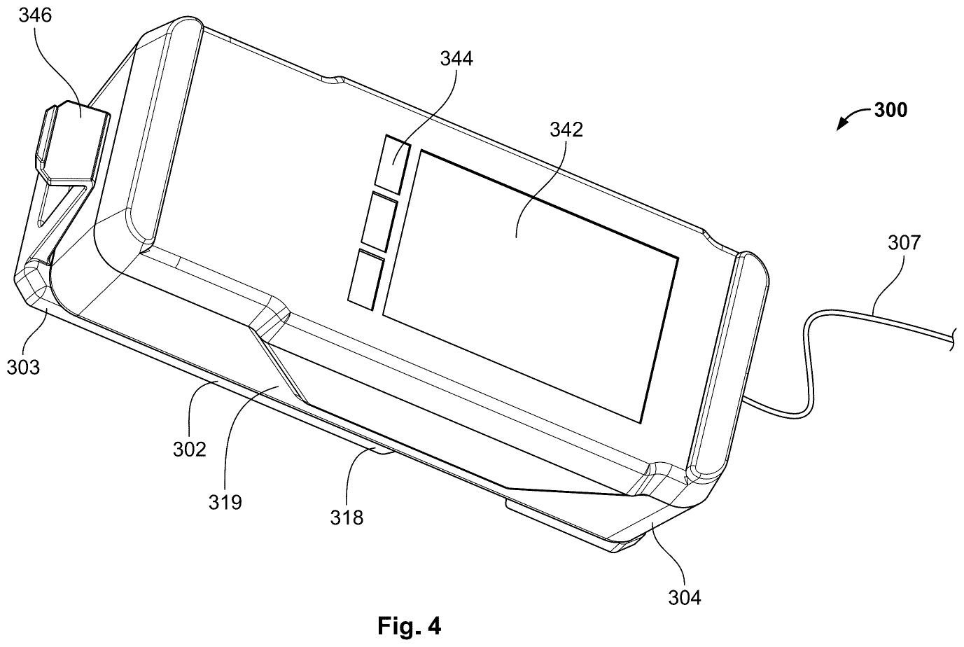

In the following, a further embodiment of an electrical connector 300 will be explained in detail with reference to FIGS. 4 to 7. In this example, a first connector element 302 comprises a base plate 303, forming a housing 318, which can be attached to a heating system. For instance, the heating system is positioned around a heat shrink product to be installed. After the installation process, the first connector element 302 remains in place, so that the documentation of the installation process remains on site.

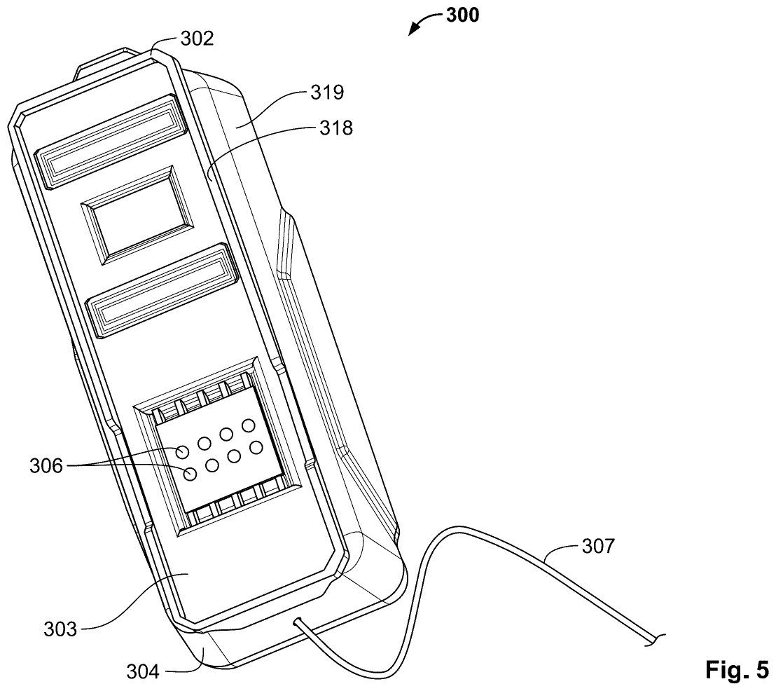

The second connector element 304, as shown in FIG. 5, includes a housing 319 which in an integrated form contains a control unit which is able to read out information from an information storage unit 312 arranged on the first connector element 302. The control unit is further operable to control the installation process and to provide the heating power required according to the information read from the information storage unit 312 to the heating system.

The second connector element 304 comprises a microcontroller and switching circuitry which allow to feed power to the heating system according to a defined timing sequence and with a defined voltage and/or current value. The second connector element 304 draws electric power from a battery or other power source, e. g. a mains power source, via an electric lead 307 shown in FIG. 4.

As shown in FIG. 4, an operator can monitor the heating process via a display device 342, for instance a liquid crystal display (LCD). Furthermore, keys 344 are provided so that an operator is able to interfere with the heating process and/or to input information to be stored in the information storage unit 312 arranged at the heating system. Instead of separate keys 344, the display device 342 may also be directly touch sensitive and thus may function as an input device.

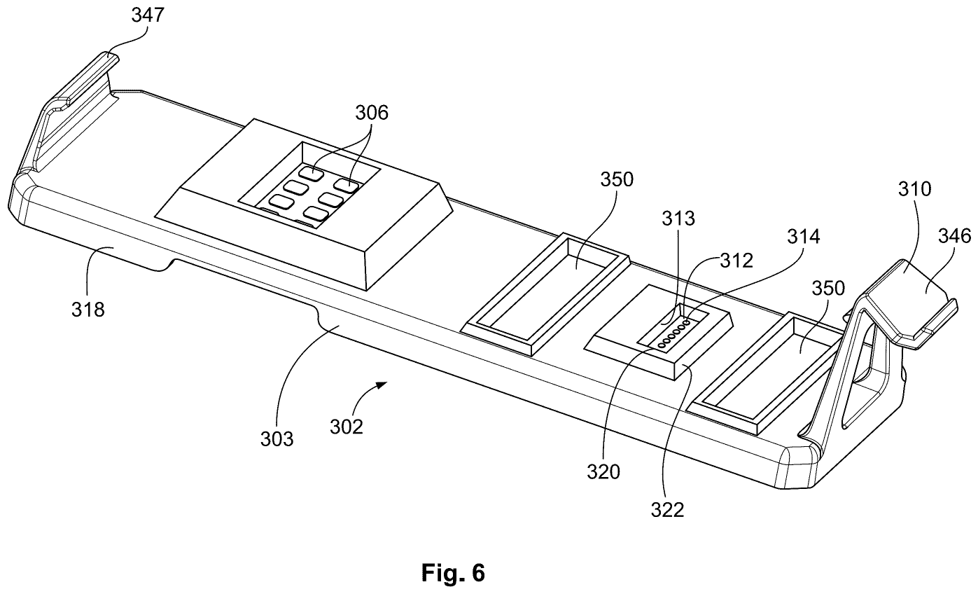

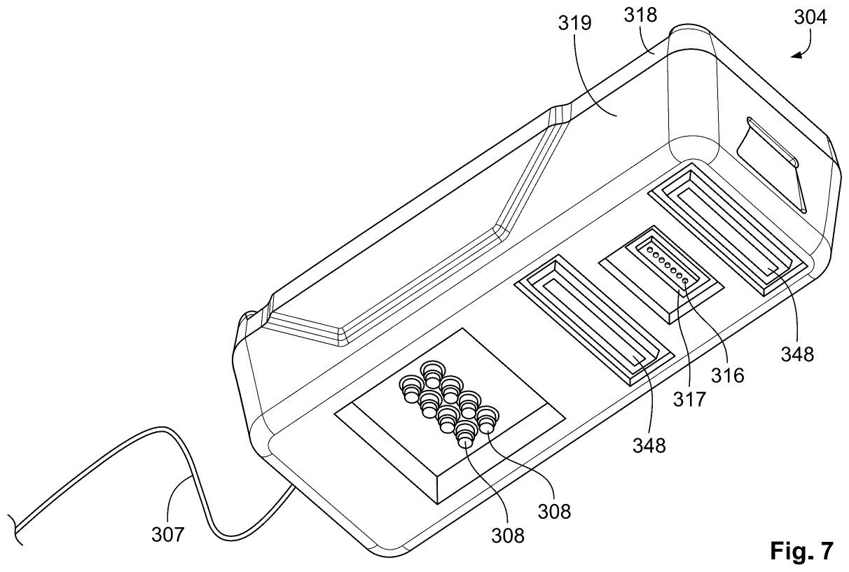

For securing the second connector element 304 at the first connector element 302, a locking device 310 for instance in the form of a snap hook 346, a hinge hook 347, and two magnets 348 interacting with respective steel plates 350 are provided, as shown in FIGS. 6 and 7. However, only one locking device 310 and also different concepts of releasable fixing elements (e. g. screws or different snap fit mechanisms) may be provided according to the present disclosure.

Instead of using a plug connector, the power connection is effected via an abutting contact employing contact pads and compressible spring biased contacts. In particular, as shown in FIG. 6, the first connector element 302 comprises an array of contact pads forming the first power terminals 306. As shown in FIG. 7, the mating second power terminals 308 comprise compressible, spring biased terminals. The second power terminals 308 are compressed in the state where the second connector element 304 is fixed at the first connector element 302, so that due to the outwardly pressing spring force of each power terminal 308 a safe electrical contact is established and maintained throughout the installation process. This is important for conducting the relatively high currents that are uses during the heating process.

As shown in FIG. 6, the first connector element 302 is provided with an information storage unit 312. The information storage unit 312 is electrically contacted via a row of first contact elements 314 which are part of a communication terminal 313. The information storage unit 312, comprising e.g. a PROM, EPROM or EEPROM, is beneficially located within the receiving first connector 302, the first connector 302 being connectable to the heating unit 203. The information storage unit 312 is operable to automatically provide all the stored information to the control unit, when the connection is made. Depending on the type of PROM interface, a minimum of 1 (1-wire), 2 (I²C), or 3 (SPI) additional contacts will be required to read-out the data.

Mating second contact elements 316 are arranged at the second connector element 304, as shown in FIG. 7. It should be noted that these second contact elements 316 are depicted only schematically and not to scale. The second contact elements 316 are part of a mating connector 317 for contacting the communication terminal 314. The abutting electrical contact is established by the normal force generated by the magnets 348 on the steel plates 350, and the locking device 310, when attaching the second connector element 304 at the first connector element 302. Of course, also a plug connection or a sliding spring contact may be used at the communication terminal 313. Further, the second contact elements 316 may also comprise compressible, spring biased terminals as described above for the second power terminals 308. These terminals are compressed in the state where the second connector element 304 is fixed at the first connector element 302, so that due to the outwardly pressing spring force of each second contact element 316 a safe electrical contact is established and maintained throughout the installation process.

The information storage unit 312 is similar to the information storage unit described with reference to FIGS. 1 and 2 and provides the same advantages. In particular, the information storage unit 312 comprises a memory module 322 mounted on a circuit carrier 320, as shown in FIG. 6. In addition to the examples previously described, the second connector element 304 integrally accommodates inside its housing 319 a control unit, so that only an external power source (e. g. a battery pack or a mains power supply) is needed for installing a heat shrink component to which the heating system with the first connector element 302 is attached. However, also further control units may be connected to the second connector element 304. In this case, the controller inside the second connector element 304 is operated as a slave. In particular, for applications where the heating unit 203 comprises a plurality of heating elements 205, further at least widely identical control units may be connected to the heating unit 203 for example using multiple, at least largely identical first connector elements 302.

As shown in FIG. 5, the surface of the base plate 303, which opposes the second connector element 304, is connectable to a heating system in a manner that the first power terminals 306 are connected to the heating elements of the heating unit. Thus, under the control of the control unit embedded in the second connector element 304, the heating elements are provided with electrical power. The heat shrink component attached to the heating elements is heated up according to a defined temperature and timing schedule based on the information read from the information storage unit 312.

It should be noted that, although in the previous description only a power transmission via ohmic contacts has been mentioned, a wireless power transmission can also be used with the connector according to the present disclosure. For instance, an inductive contactless coupling can be provided for the power transmission. The inductive coupling has the advantage of being robust and completely sealed against intrusion of humidity and dust.

The present disclosure also relates to a method for installing a heat shrink cover, the method comprising the following steps: providing the heat shrink cover with at least one heating element 205, wherein the heating element is electrically connected to a first connector element 102, 202, 302 of an electrical connector 100, 200, 300, connecting a power source to the at least one heating element 205 by connecting the mating second connector element 104, 204, 304 to the first connector element 102, 202, 302; via the communication interface, reading out the data stored in the information storage unit 112, 212, 312; supplying electrical power to the at least one heating element 205 for performing a heating process according to the data stored in the information storage unit 112, 212, 312.

The power source is connected by connecting the control unit 226 to the at least one heating element 205. Further, by the control unit 226, information indicative of a required heating profile from the storage unit is read out from the information storage unit 112, 212, 312. Accordingly, electrical power is supplied to the at least one heating element 205 for performing a heating process according to the required heating profile. In this manner, a particularly safe and efficient torchless installation of heat shrink covers can be achieved.

If the information storage unit 112, 212, 312 comprises an electronic storage unit, the method may further comprise the step of storing information inputted by the control unit 226 in the electronic storage unit during or after the heating process has been completed. As mentioned above, this information may be helpful for documentation purposes and in case of a failure analysis.

In an embodiment, the control unit 226 communicates with further electrical connectors, the first connector elements 202 of which are connected to further electric components. For instance, the type and/or presence of a battery 236 and/or a power generator 234 may be detected by the control unit 226.

What is claimed is:

1. An electrical connector, comprising:
a first connector element including a housing and a first power terminal providing electrical power to a heating element of a heating system;
a second connector element mateable with the first connector element, the second connector element including a second power terminal mateable with the first power terminal;
an information storage unit storing a data usable for operating the heating system; and
a communication interface reading out the data stored in the information storage unit.

2. The electrical connector of claim 1, wherein the information storage unit is an electronic storage unit.

3. The electrical connector of claim 2, wherein the electronic storage unit is at least one of a programmable read-only memory, an erasable programmable read-only memory, and an electrically erasable programmable read-only memory.

4. The electrical connector of claim 1, wherein the communication interface includes a communication terminal having a plurality of first contact elements connectable to a plurality of second contact element of a mating electrically conductive connector.

5. The electrical connector of claim 1, wherein the communication interface is a wireless communication interface.

6. The electrical connector of claim 1, wherein the communication interface provides a bidirectional communication between the information storage unit and a control unit.

7. The electrical connector of claim 1, wherein the information storage unit includes an RFID tag arranged at the housing of the first connector element.

8. The electrical connector of claim 7, wherein the communication interface includes an RFID reader at the second connector element.

9. The electrical connector of claim 1, wherein the information storage unit includes a printed circuit board mounted in the housing with a memory module assembled on the printed circuit board.

10. The electrical connector of claim 1, wherein the first connector element receives a temperature measurement signal from an external temperature sensor.

11. A heating system for a heat shrink component, comprising:
a heating unit having a heating element; and
an electrical connector including:
a first connector element having a housing and a first power terminal providing electrical power to the heating element;
a second connector element mateable with the first connector element, the second connector element including a second power terminal mateable with the first power terminal;
an information storage unit storing a data usable for operating the heating system; and
a communication interface reading out the data stored in the information storage unit.

12. The heating system of claim 11, further comprising a control unit controlling a power supply to the heating element.

13. The heating system of claim 12, wherein the control unit communicates with the information storage unit via the communication interface.

14. The heating system of claim 12, further comprising a power source that provides the power supply, the power source is a power generator and/or a battery pack.

15. The heating system of claim 14, wherein at least one of the power generator and the battery pack has an electrical connector bidirectionally communicating with the control unit.

16. A method, comprising:
providing a heat shrink cover having a heating element, the heating element is electrically connected to a first connector element of an electrical connector;
connecting a power source to the heating element by connecting a second connector element to the first connector element;
reading out a data stored in an information storage unit via a communication interface; and
supplying an electrical power to the heating element to perform a heating process according to the data stored in the information storage unit.

17. The method of claim 16, wherein the information storage unit includes an electronic storage unit.

18. The method of claim 17, further comprising storing an information input by a control unit in the electronic storage unit after the heating process has been completed.

19. The method of claim 18, wherein the control unit communicates with a plurality of further electrical connectors that are connected to a plurality of further electric components.
